(19) United States
(12) Patent Application Publication
(10) Pub. No.: US 2007/0232694 A1
(43) Pub. Date: Oct. 4, 2007

(54) SKIN CLEANSER

(76) Inventor: Douglas Howard Phillips, Millerton, OK (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/692,613

(22) Filed: Mar. 28, 2007

Related U.S. Application Data
(63) Continuation-in-part of application No. 11/392,171, filed on Mar. 29, 2006.

(51) Int. Cl. A61Q 19/10

(52) U.S. Cl. 514/518; 510/109

(57) ABSTRACT

This invention provides a skin cleanser that comprises an anionic surfactant and a hypochlorite salt, and optionally with an anionic dye and/or an abrasive.

### CROSS-REFERENCE TO RELATED APPLICATIONS

This application is a continuation-in-part of U.S. Ser. No. 11/392,171, filed Mar. 29, 2006, which is hereby incorporated by reference in its entirety.

### BACKGROUND OF THE INVENTION

1. Field of the Invention

The present invention relates to a dermatological treatment for use following injury to the skin from noxious agents, such as poison ivy, insect bites, animal bites and microbial infection.

2. Description of the Related Art

Skin protects people and animals from environmental hazards, such as heat, cold, dehydration, insect bites, and microbial infection. Injuries to skin often result from noxious agents from plants, insects, and other animals, many of which produce toxins and venoms as a means of survival. Skin injuries are particularly difficult to treat when a noxious agent penetrates through the epidermis to the subcutaneous layers underlying it, because the epidermis limits access of therapeutic agents. For this reason, toxins beneath the surface of the skin usually resist rapid treatment, especially by skin cleansers that only wash the surface of the skin.

Toxic substances can penetrate to the subcutaneous layers not only through direct introduction by stings and bites, but also by entering pores in the skin and, for lipophilic compounds, passive diffusion through the skin. Urushiol oil from poison ivy, poison oak, and poison sumac is an example of a noxious agent that can penetrate even unbroken skin.

Similarly, bacterial and fungal infections also become difficult to treat once infection penetrates to the subcutaneous layers. Treatment then often requires systemic administration of antibiotics, with the attendant short-term risks of drug side effects, and the longer term risk of generating drug-resistant strains of the offending organism. Methicillin-resistant Staphylococcus aureus, a Gram-positive bacterial strain commonly known as MRSA (as opposed to methicillin-susceptible Staphylococcus aureus, MSSA), now poses a considerable threat because it resists the action of most antibiotics. Skin infections pose a particular problem in the healthcare context because of the ubiquity of MRSA in hospitals and nursing homes, and incidence of decubitus ulcers (bed sores), which often become infected. Other clinically-important bacterial strain include a S. aureus strain resistant to vancomycin (VRSA).

Previous efforts to treat skin injuries and infections have used antiseptics or surfactants. For example, Dakin's solution, which consists of the antiseptics sodium hypochlorite (0.125-0.5%) and boric acid (4%) has been used since before World War I for treating wounds. Dakin's solution, however, decomposes within a few days, and consequently must be prepared as needed. Moreover, studies have shown that Dakin's solution has limited efficacy in treating bacterial infections of the skin.

Similarly, surfactants have been used for washing debris and bacteria from the surface of the skin by lowering its surface tension so that the foreign material does not adhere as well and can be washed away. Nevertheless, any infective material that resists washing away remains on the skin as a viable source of infection. Furthermore, cleansing only the skin surface fails to deal with any noxious agents that have penetrated to the subcutaneous layers, and thereby provides at best partial palliation of symptoms.

Thus there is a need for a way to remove noxious agents and to treat microbial infections that can be applied topically, rather than systemically, and yet exert therapeutic action on the subcutaneous layers of the skin.

### SUMMARY OF THE INVENTION

An embodiment provides a skin cleanser and antiseptic that acts not only upon the surface of the skin but also the subcutaneous layers, by providing a combination of an anionic surfactant with an oxidizing agent, optionally with an abrasive.

An embodiment provides a skin cleanser comprising: at least one anionic surfactant, and a biologically-compatible hypochlorite salt.

In a preferred embodiment, the cleanser comprises sodium dodecylbenzenesulfonate and sodium hypochlorite as the anionic surfactant and oxidizing agent, respectively, and powdered sodium carbonate and calcium carbonate as the abrasives.

### DETAILED DESCRIPTION OF THE PREFERRED EMBODIMENTS

Definitions

Unless otherwise specified, technical terms here take their usual meanings, specifically those specified in the McGraw-Hill Dictionary of Scientific and Technical Terms, 6^{th} edition.

“Biologically-compatible” as used here refers to substances that in contact with humans or animals when used as described as part of the inventive cleanser do not result in deleterious consequences for the user.

“Noxious agent” refers to materials that injure the skin, and includes venoms, toxins, allergens, and microbes such as bacteria, fungi, and protozoans associated with dermatological pathologies. Two important classes of noxious agents described below are toxins and bacterial infections.

Bacterial infections pose a particular threat, especially in the hospital context. Bedridden patients often develop decubitus ulcers that tend to become infected. Many hospitals are colonized by especially virulent bacterial strains, especially drug-resistant ones such as MRSA and more recently VRSA, that pose serious hazards to hospitalized patients as fewer and fewer antibiotics retain activity against them.

Common skin infections include cellulitis, erysipelas, impetigo, folliculitis, furuncles and carbuncles. Cellulitis is an infection of the dermis and subcutaneous tissue that has poorly demarcated borders and is usually caused by Streptococcus or Staphylococcus species. Erysipelas is a superficial form of cellulitis with sharply demarcated borders and is caused almost exclusively by Streptococcus. Impetigo is also caused by Streptococcus or Staphylococcus and can lead to lifting of the stratum corneum resulting in the commonly seen bullous effect. Folliculitis is an inflammation of the hair follicles. When the infection is bacterial rather than mechanical in nature, it is most commonly caused by Staphylococcus. If antibiotics are required, one that is active against gram-positive organisms such as penicillinase-resistant penicillins, cephalosporins, macrolides, or fluoroquinolones should generally be chosen. Children, patients who have diabetes, or patients who have immunodeficiencies are more susceptible to gram-negative infections and may require treatment with a second- or third-generation cephalosporin. Other less common skin infections are the result from Enterococcus faecalis, Proteus mirabilis, and E. coli. It is common after scratches from cats to develop an Bartonella henselae and Bartonella clarridgeiae infection resulting in local inflammation and regional lymphadenopathy and systemic malaise and fever. The cause of Lyme disease is a bacterial infection of the skin with a spirochete from the species complex Borrelia burgdorferi sensu lato, which is most often acquired from the skin bite of an infected Ixodes tick. Bubonic plague, which is caused by the enterobacteria Yersinia pestis, is an infection that most often occurs when a person is bitten by a rat or flea that has fed on an infected rodent. Initial symptoms are chills, fever, diarrhea, headaches, and the swelling of the infected lymph nodes near the area of the skin byte. Rocky Moutain Spotted Fever is a disease caused by Rickettsia rickettsii, a species of bacteria that is spread to humans by hard ticks. Initial signs and symptoms of the disease include sudden onset of fever, headache, and muscle pain, followed by development of rash. Tetanus is a medical condition characterized by a prolonged contraction of skeletal muscle fibers. The primary symptoms are caused by tetanospasmin, a neurotoxin produced by the Gram-positive, obligate anaerobic bacterium Clostridium tetani. Infection generally occurs through wound contamination, and often involves a cut or deep puncture wound. Tularemia is an infectious disease caused by the bacterium Francisella tularensis. The primary vectors are ticks and deer flies. Flu-like symptoms develop between 1-14 days after infection (most likely 3-5 days.) If the patient is infected through an insect or tick bite, an eschar may develop at the bite site. Typhus is an infection, caused by Rickettsia felis, that can be transmitted by fleas, chiggers or direct human contact from infected lesions. A symptom common to all forms of typhus is a fever which may reach 39° C. (102° F.), and sometimes, symptoms include headaches, backaches, and arthralgia. Anthrax is an acute infectious disease caused by the bacterium Bacillus anthracis, a gram positive bacteria, and is highly lethal in some forms to both humans and domestic animals. Cutaneous infection is manifested by progressive stages from an erythematous papule to ulceration and finally to formation of a black scar (i.e., eschar), which can result in death.

Noxious agents that penetrate to the subcutaneous layers resist treatment by most topically applied therapies because the top layer of skin impedes direct contact between the therapeutic substance and the agent. In an embodiment, the inventive cleanser solves this problem by using both chemical and physical methods to facilitate access to any noxious agents below the skin surface.

Anionic surfactants are compounds that contain uncharged lipophilic and negatively-charged hydrophilic moieties within one molecule. Reports suggest that they cause the skin to swell and increase in permeability, and consequently they are often avoided in topically-applied products, such as cosmetics. While it is undesirable in a cosmetic formulation, in the present invention increased skin permeability is used to advantage to provide greater access to the subcutaneous layers of the skin.

An embodiment provides a skin cleanser comprising at least one anionic surfactant and a biologically-compatible hypochlorite salt. The skin cleanser may further comprise an abrasive and/or an ionic ingredient, such as simple salt (e.g., NaCl) or a dye. In an embodiment, the cleanser is an aqueous solution or mixture containing an amount of the anionic surfactant in the range of from about 0.1% to 25% by volume, preferably about 0.5% to about 10% by volume, based on total volume of the cleanser. In an embodiment, the cleanser is an aqueous solution or mixture containing an amount of the hypochlorite salt in the range of from about 0.01% to about 5.0% by volume, preferably from about 0.1% to about 1.0% by volume, based on total volume of the cleanser. In an embodiment, the cleanser is an aqueous solution or mixture containing an amount of the abrasive in the range of from about 0.01% to about 5.0% by volume, preferably from about 0.1% to about 1.0% by volume, based on total volume of the cleanser. In an embodiment, the ionic ingredient is an anionic dye that comprises one or more selected from Red 40, Red 3, Yellow 5, Yellow 6, Blue 1 and Blue 2.

A preferred embodiment of this invention uses sodium dodecylbenzenesulfonate as the anionic surfactant, at a concentration exceeding approximately 1% by volume, e.g., about 1% to about 5%, and sodium hypochlorite, approximately 0.1% to 5% by volume, and a mild abrasive, e.g., calcium carbonate and/or sodium carbonate, approximately 0.1% to 5% by volume. The exact concentrations and proportions of the anionic surfactant and the sodium hypochlorite are not critical, and may be determined by routine experimentation guided by the disclosure provided herein.

Anionic Surfactants

A variety of anionic surfactants, such as amphiphilic sulfates, sulfonates, phosphonates, phosphates, and carboxylates can be used in the present invention. Specifically, alkyl ether phosphates, alkyl ether carboxylic acids and salts, alkyl ether sulfates, alkyl naphthalene sulfonates, alkyl phosphates, alkyl benzenesulfonates, alkyl phenol ether phosphates, alkyl phenol ether sulfates, alpha olefin sulfonates, aromatic hydrocarbon sulfonic acids, condensed naphthalene sulfonates, di-alkyl sulfosuccinates, fatty alcohol sulfates, mono-alkyl sulfosuccinates, alkyl sulfosuccinamates, and naphthalene sulfonates can all be used. In the above list “alkyl” refers to C₁-C₂₀ aliphatic hydrocarbons, and “fatty alcohol” refers to C₈-C₃₀ aliphatic alcohols. These surfactants are all items of commerce, and therefore readily available and well-known to those skilled in the art.

Preferred embodiments of the present invention employ sodium laureth sulfate or sodium lauryl sulfate; a more preferred embodiment uses sodium dodecylbenzenesulfonate as the anionic surfactant.

Any biologically-compatible salt of the anionic surfactant can be used, as the identity of the counter ion is not critical, but the sodium forms are readily available commercially and preferred in some embodiments.

Hypochlorite Salts

Any biologically-compatible salt of hypochlorous acid can be used, but the sodium and calcium salts are readily available and preferred in some embodiments.

Another preferred embodiment additionally incorporates an anionic dye, which surprisingly increases the anti-bacterial efficacy. Anionic dyes are substances that absorb light in the visible region and possess a negative charge at physiological pH, where the balancing positive charge comes from any biologically-compatible cation. Although the mechanism of this increase in efficacy is not known, and while not wishing to be bound by theory, it is believed that anionic dyes incorporate into bacterial cell walls, where they may photosensitize production of active oxygen species (singlet oxygen, hydroxyl radicals, or superoxide radicals) from atmospheric oxygen.

Abrasives

Cleansing of the skin through use of the present invention can in some embodiments be further improved through inclusion of a mild, biologically-compatible abrasive in the inventive cleanser. Suitable abrasives include powdered sodium carbonate, sodium bicarbonate, calcium carbonate, sodium borate, silica, diatomaceous earth, and cellulose-based materials, such as the shells of almonds, apricots, or walnuts. The identity of the abrasive is not critical, provided it is biologically-compatible.

In an embodiment, this invention also achieves effectiveness through the optional use of gentle abrasion to increase chemical transport. Embodiments of this invention are intended to provide a cleansing benefit when the skin has been harmed by a puncture wound, caused by a sting or bite in the case of attacks by venomous insects, snakes and other animals; or a lesion such as an open, weeping rash in the case of poison ivy and similar irritants. In an embodiment, this cleanser invention uses gentle abrasion as a method to open up the pathway from the skin surface, where the cleanser is topically applied, to the physical location of the subcutaneously-located toxin or venom.

In an embodiment, this invention uses chemically-passive abrasives to facilitate transport of the cleanser to the allergen or toxin. In a preferred embodiment these abrasives are carbonate salts, although other biocompatible mild abrasives can be used. For example, a cotton-tipped swab can be used to abrade tissue and disturb the scarred collagen tissue formed by the body's cells that restricts access to deeper levels of the skin.

Use

In an embodiment, this invention acts quickly, often within one minute, when used as a poison ivy cleanser. This is often advantageous because when the itching stops, the scratching stops, thereby limiting the spread of the urushiol oil and the spreading of inflammation to nearby areas of the skin. Most common cleansers and other forms of treatment for poison ivy exert their action more slowly, and have limited effectiveness when first applied. The application of the skin cleanser may be in conjunction with other treatments, e.g., administration of antibiotics. For example, the skin cleanser may be used to treat a patient undergoing a course of treatment with oral and/or intravenous antibiotic(s).

In an embodiment, an oral, topical and/or intravenous (IV) antibiotic compound can be given to the patient before or concurrently with applying the cleanser. In another embodiment, it is possible to combine the cleanser with one or more topical antibiotics. The standard of care is typically a topical antibiotic cream for simple impetigo, warm compresses and drainage for abscesses, an oral antibiotic, or an intravenous antibiotic for more serious or persistent infections. Examples of topical antibiotics include mupirocin, triclosan, bacitracin, chloramphenicol, clindamycin, erythromycin, fusidic acid, gentamicin, miconazol, mupirocin, neomycin, polymyxin B, sulfamides, tetracyclines, benzoyle peroxide or azelaic acid. Examples of commonly used oral antibiotics include the first-generation cephalosporins such as a penicillin (methicillin, oxacillin, cloxacillin or flucloxacillin), or cephalosporins such as cephalexin, or amoxicillin/clavulanate, pristinamycin, dicloxacillin, cefadroxil, or stronger oral antibiotics such as sodium fusidate, tetracyclines, linezolid, doxycycline, minocycline, clindamycin and trimethoprim-sulfamethoxazole, or combination treatments such as trimethoprim-sulfamethoxazole and rifampin. More serious and multi-drug resistant bacterial infections can usually be treated in the hospital with the intravenous antibiotics such as the glycopeptide antibiotics such as vancomycin or teicoplanin, or other IV antibiotics such as levofloxacin, linezolid (IV or oral), quinupristin/dalfopristin, daptomycin, or tigecycline.

Optional Formulations

Preparing a paste is the preferred method for application of the cleanser to the skin. The sodium carbonate and/or the calcium carbonate mixing percentage is preferably maintained in an amount that is adequate to achieve the goal of having a slightly gritty mixture when a thick paste is made using water.

Although various embodiments of the invention have been described as a powder, in other embodiments it can easily be formulated as a liquid, ointment, paste, or gel, by methods well-known to those skilled in the art. For example, addition of the anionic surfactant and sodium hypochlorite to aqueous methylcellulose can provide a gel.

The cleanser can also include optional inactive ingredients in addition to the ingredients described above. For example, coloring agents such as cocoa bean powder (1-30% by weight), or binding agents such as talc powder (1-30% by weight) can be included to impart a skin-tone color to the cleanser, or to improve its physical feel, respectively. Similarly, fragrances can be incorporated into the cleanser, if desired.

### EXAMPLE 1

Testing was conducted at a pathology laboratory certified for microbiology testing by a physician and a microbiologist. A double blind, randomized controlled experiment was conducted to evaluate the surfactant compounds against bacteria in Petri dishes.

Bacterial strain: Two well characterized strains of methicillin-sensitive Staphylococcus aureus (MSSA) and methicillin-resistant Staphylococcus aureus (MRSA) were used. Specifically, experiments used ATCC 29213 (MSSA) and ATCC 43330 (MRSA), both beta-lactamase positive strains, which represent greater than 90% of the respective strains in the American population.

Petri dish preparation: A sterile cotton swab (American Scientific Products, McGraw Park, Ill.) was dipped into the cultures and used to swab the entire surface of 150×15 mm Petri dishes containing 75 ml of standard Mueller-Hinton agar. Two Petri dishes were inoculated with ATCC 29213 (MSSA and two Petri dishes with ATCC 43330 (MRSA). One Petri dish of each group (MSSA and MRSA) was set aside as the controls. The other two Petri dishes (MSSA and MRSA) were divided up in quadrants, and each quadrant was labeled B, C, D or E.

Cleanser compositions were prepared as follows: A surfactant solution containing about 10% by volume of sodium dodecylbenzenesulfonate was prepared. An aqueous stock solution containing 0.5% by volume sodium hypochlorite and 0.5% by volume abrasive (calcium carbonate and sodium carbonate) was prepared. The surfactant solution and stock solution were mixed in various ratios to produce four skin cleanser solutions having four different surfactant concentrations of 0.5%, 1%, 2% and 8%, by volume. The amount of sodium hypochlorite, calcium carbonate and sodium carbonate in each of the four skin cleanser solutions was less than 1% concentration by volume.

Cleanser Testing: Four samples of the cleanser with the four different concentrations of the surfactant (0.5%, 1%, 2% and 8%) were placed into four separate, unmarked bottles. Each bottle was randomly labeled (B, C, D, or E), and the microbiologist conducting the study was unaware of any difference between the solutions.

Application: Holding each bottle vertically, the microbiologist added a single drop from each bottle (B, C, D, or E) to the corresponding quadrant of the labeled Petri dish. All four Petri dishes were placed in an incubator overnight at 37 degrees Celsius, and examined 20 hours later. Petri dishes were compared to the corresponding controls, and zones of inhibition were characterized by the largest point of diameter of the circle or oval.

Results: The solution with the lowest surfactant concentration, 0.5%, showed no difference between the controls, while the 1% and 2% concentrations inhibited approximately 50% of the colony forming units (CFUs). The 8% concentration showed clear inhibition of the bacteria in a large circle of approximately 40 mm in diameter.

### EXAMPLE 2

The same protocol as described in Example 1 above was used to test various concentrations of the sodium dodecylbenzenesulfonate surfactant compound against the MRSA strains and revealed a clear trend, with higher concentrations of the anionic surfactant causing larger zones of inhibition (range from zero (control) to 42.3 mm (14.80% concentration)). Inhibition zone diameters shown in the table below were averaged over three repeated experiments.

| Diameter of Zone of | |
|---|---|
| Inhibition (mm) | Surfactant conc. (vol. %) |
| 42.3 | 14.80% |
| 41.7 | 4.90% |
| 39.3 | 4.00% |
| 39 | 6.50% |
| 37.3 | 3.30% |
| 35.3 | 2.30% |
| 34 | 9.30% |
| 33.7 | 2.50% |
| 32.7 | 2.80% |
| No Change | 1.00% |
| No Change | 0.00% |

### EXAMPLE 3

Four cleanser compositions were prepared and tested in the manner described in Example 1, except that each cleanser contained a different anionic surfactant. These cleanser compositions included two aromatic anionic surfactants (sodium cholate and sodium deoxycholate), and two long chain anionic surfactants (N-lauroylsarcosine sodium salt and sodium dodecylbenzenesulfonate). Four control compositions containing only the surfactants were also prepared and tested in a similar manner.

All four cleansers evaluated in this example showed definite effectiveness as anti-bacterial and anti-septic agents. Each of the four surfactants proved effective when mixed with water only and still greater efficacy in the presence of sodium hypochlorite.

Anti-bacterial effectiveness at a given concentration decreased in the order sodium dodecylbenzenesulfonate >N-lauroylsarcosine sodium salt >sodium cholate, sodium deoxycholate.

Sodium hypochlorite potentiated the anti-bacterial action of sodium dodecylbenzenesulfonate, resulting in a synergy of action. A 5% solution of sodium dodecylbenzenesulfonate in the stock solution (containing sodium hypochlorite) was as effective as a 10% concentration of the surfactant in water (a solution lacking sodium hypochlorite).

### EXAMPLE 4

Addition of 5% dye by volume to a solution containing sodium hypochlorite and 2% concentration of sodium dodecylbenzenesulfonate dramatically improved the effectiveness of the cleanser as an anti-bacterial agent. The zone of inhibition increased 66% (from 62 mm to 80 mm diameter) when 5% (by volume) ionic dye (AmeriMist Air Brush Food Color manufactured by AmeriColor, Inc., Lot# 0681C, Color Turquoise #528) was added.

### EXAMPLE 5

Action against Gram-positives such as Enterococcus: A 68-year-old man with long history of diabetes was admitted from his hospice care home to an acute care facility hospital secondary to an infected decubitus ulcer (bedsore). This patient's sacral ulcer tested positive from culture swab for Enterococcus, a common Gram-positive bacterium for infecting bedsores. Immediately upon admission, the patient was placed on antibiotics (ciprofloxacin). Over the next five days, the 4 cm open, oozing ulcer with erythematous margins and discharging pus showed signs of worsening. On day five, the treating physician directly cultured the wound again with two cotton swabs. Cotton swab #1, the control, was placed directly in the sealed container based on hospital protocol. Cotton swab #2 was placed into the sealed container, but one single vertical drop of a cleanser solution (prepared as described in Example 1). Both swabs were sent to the lab and a count of colony-forming units (CFUs) ordered. Forty-eight hours later, the culture of cotton swab #1 (the control) exhibited 22 CFUs, while the culture of cotton swab #2 had only two CFUs.

Moreover, the patient's ulcer showed marked improvement within 24 hours of the first application of the cleanser. There was sufficient resolution (decreased erythema, lower induration, skin color improvement from red to pink, and decrease pus discharge) of the ulcer over the next four days for the patient to leave the hospital.

### EXAMPLE 6

Action against Mycobacteria: A 39-year-old female with four month long history of an infection on the posterior aspect of her right ring finger was treated. The infected areas were culture positive for mycobacteria marinum, with symptoms of infection resulting in a 4 cm long patchy zone of erythema, induration, and oozing from the wound. After failing two full courses of oral antibiotics, over the previous four months, the patient was given a third round of antibiotics, this time Clarythromycin, after her finger's condition had worsened. After eleven days of antibiotics and no change in symptoms, the patient applied two drops of the cleanser (2% sodium dodecylbenzenesulfonate with sodium hypochlorite and an abrasive, prepared as described in Example 1) into the wound three times per day where a 5 mm biopsy had broken the skin, and applied gentle abrasion as directed. Within 24 hours of the first application, the wound showed marked improvement in the overall signs of infection. Within 72 hours the area of the open skin lesions had continued decrease in induration, erythema and signs of infection. Patient's symptoms ultimately improved with the combination of antibiotics and topical surfactant compound.

### EXAMPLE 7

Goat and other farm animals are very susceptible to infections. Often, if a bad infection occurs, the animal will be separated and sacrificed. A goat with an ophthalmic infection resulting in large greenish discharge from both eyes for three weeks. The cleanser (2% sodium dodecylbenzenesulfonate with sodium hypochlorite, prepared as described in Example 1) was squirted into the eyes of the goat two days before sacrifice. Within 24 hours, the goat's eye infections had improved, and the goat was able to see out of one of the eyes. The treatment was continued for five days resulting in the full resolution of the goat's symptoms.

### EXAMPLE 8

Five patients with confirmed MRSA positive infections by their doctors were treated with the cleanser (2% sodium dodecylbenzenesulfonate and sodium hypochlorite, prepared as described in Example 1) by direct topical application on the surface of their skin and open lesions. Within 24 hours, three of the patients improved such that their areas of skin erythema, induration and open lesions appeared more normal. All five patient's infected area showed complete resolution of his or her acute symptoms within five days of starting the treatment.

### EXAMPLE 9

A patient with a 12 month history of culture positive MRSA returned after a hunting trip with a dozen skin lesions on his skin from his hips to axillary region. Patient was started on oral and topical sulfamethoxazone and trimethoprim combination antibiotics, with no change in symptoms. On day 6 of the antibiotics, patient applied the cleanser (2% sodium dodecylbenzenesulfonate and sodium hypochlorite, prepared as described in Example 1) on the skin of three of the 12 lesions, and experienced marked improvement over the first 24 hours and by the fourth day patients three lesions had returned to a healthy pink color. He then applied the cleanser to all twelve lesions, and after seven days of subsequent cleanser treatment, combined with the continuation of his antibiotic regiment, showed all the lesions dried up with a healthy fleshy skin toned appearance.

### EXAMPLE 10

A 35 year old male patient was diagnosed by a physician with MRSA skin infection, with two active 1 cm and 4 cm skin lesions. Patient applied the cleanser (2% sodium dodecylbenzenesulfonate and sodium hypochlorite, prepared as described in Example 1) on the small 1 cm lesion three times per day with concomitant application of gentle abrasion while leaving the larger lesion alone as the control. Within one day, the smaller lesion had dried and patient reported in the appearance and feel of the infection under the skin as well, reporting less inflammation. After ten days the smaller lesion had turned a healthy flesh toned color with no scab or other remnant, and complete resolution. On day five, patient began using the cleanser on the larger lesion, and this larger lesion, which had been unchanged compared to the healing of the small lesion, showed immediate improvement after the application of the cleanser, with similar course of action as the smaller lesion.

Although the invention has been illustrated by certain of the preceding alternative embodiments and methods of use, it is not to be construed as being limited thereby; but rather, the invention encompasses the generic area as hereinbefore disclosed. Various modifications and embodiments can be made without departing from the spirit and scope thereof.

What is claimed is:

1. A skin cleanser comprising:
at least one anionic surfactant, and
a biologically-compatible hypochlorite salt.

2. The cleanser of claim 1 wherein the surfactant is selected from the group consisting of biologically-compatible sulfonates, sulfates, phosphonates, phosphates, and carboxylates.

3. The cleanser of claim 2, wherein the surfactant is selected from the group consisting of the biologically-compatible salts of an alkyl ether phosphate, alkyl ether carboxylate, alkyl ether sulfate, alkyl naphthalene sulfonate, alkyl phosphate, alkyl benzenesulfonate, alkyl phenol ether phosphate, alkyl phenol ether sulfate, alpha olefin sulfonate, aromatic hydrocarbon sulfonic acid, condensed naphthalene sulfonate, di-alkyl sulfosuccinate, fatty alcohol sulfate, mono-alkyl sulfosuccinate, alkyl sulfosuccinamate, and a naphthalene sulfonate.

4. The cleanser of claim 3, wherein the surfactant is selected from the group consisting of biologically-compatible salt of a benzenesulfonate, alkylbenzenesulfonate, and a fatty alcohol sulfate.

5. The cleanser of claim 2, wherein the surfactant is a biologically-compatible salt of dodecylbenzenesulfonic acid.

6. The cleanser of claim 1, wherein the biologically-compatible hypochlorite salt is selected from the group consisting of sodium hypochlorite and calcium hypochlorite.

7. The cleanser of claim 1, further comprising an abrasive.

8. The cleanser of claim 7 wherein the abrasive is selected from the group consisting of sodium carbonate, sodium bicarbonate, calcium carbonate, sodium borate, silica, diatomaceous earth, and cellulose-based materials.

9. The cleanser of claim 8, wherein the abrasive is selected from the group consisting of sodium carbonate, sodium bicarbonate, and calcium carbonate.

10. The cleanser of claim 1, wherein the cleanser comprises an amount of the anionic surfactant in the range of from about 0.1% to 25% by volume based on total volume of the cleanser.

11. The cleanser of claim 10, wherein the cleanser comprises an amount of the anionic surfactant in the range of from about 0.5% to about 10% by volume based on total volume of the cleanser.

12. The cleanser of claim 1, wherein the cleanser comprises an amount of the hypochlorite salt in the range of from about 0.01% to about 5.0% by volume based on total volume of the cleanser.

13. The cleanser of claim 12, wherein the cleanser comprises an amount of the hypochlorite salt in the range of from about 0.1% and 1.0% by volume based on total volume of the cleanser.

14. The cleanser of claim 1, additionally comprising an anionic dye.

15. The cleanser of claim 14, wherein the anionic dye is selected from the group consisting of Red 40, Red 3, Yellow 5, Yellow 6, Blue 1 and Blue 2.

16. A method of cleansing the skin, comprising applying the cleanser of claim 1 to the skin of a patient in need thereof.

17. A method of treating a patient for a bacterial skin infection, comprising applying the cleanser of claim 1 to the skin of a patient in need thereof.

18. The method of claim 17, wherein the bacterial skin infection is caused by a bacterial strain selected from the group consisting of Gram-positive, Gram-negative and Acid Fast organisms.

19. The method of claim 18, wherein the bacterial strain is Gram-positive.

20. The method of claim 18, wherein the bacterial strain is selected from the group consisting of the genera Staphylococcus, Enterococcus, and Mycobacterium.

21. The method of claim 20, wherein the bacterial strain belongs to the genus Staphylococcus.

22. The method of claim 21, wherein the bacterial strain is MRSA.

23. The method of claim 17, wherein the patient is selected from the group consisting of a farm animal and a domestic animal.

24. The method of claim 17, further comprising administering an antibiotic to the patient in conjunction with the application of the cleanser.

25. The method of claim 24, wherein the antibiotic is administered orally.

26. The method of claim 24, wherein the antibiotic is administered intravenously.

27. A method of treating a patient for a decubitus ulcer, comprising applying the cleanser of claim 1 to the skin of a patient in need thereof.
